(19) United States
(12) Patent Application Publication
(10) Pub. No.: US 2026/0115990 A1
(43) Pub. Date: Apr. 30, 2026

(54) THERMOPLASTIC BOUND SHORT FIBER FILAMENT EXTRUDER

(71) Applicant: Purdue Research Foundation, West Lafayette, IN (US)

(72) Inventors: Nicholas Torgerson, Palo Alto, CA (US); Ryan Herr, Auburn Hills, MI (US); Monique Suzanne McClain, Lafayette, IN (US); Emma Schultz, Hartford, WI (US); Matthew Stuber, Dayton, OH (US); Tina Tailor, Tempe, AZ (US); Kaitlyn Yu, Princeton, NJ (US)

(73) Assignee: Purdue Research Foundation, West Lafayette, IN (US)

(21) Appl. No.: 19/375,921

(22) Filed: Oct. 31, 2025

Related U.S. Application Data
(60) Provisional application No. 63/714,518, filed on Oct. 31, 2024.

(51) Int. Cl. B29C 48/15; B29C 48/00; B29C 48/285; B29C 48/30

(52) U.S. Cl. CPC B29C 48/15; B29C 48/022; B29C 48/2886; B29C 48/301

(57) ABSTRACT

An extrusion device for fiber reinforced polymer filament may include an extruder which outputs a thermoplastic melt into a flow path. An incorporation chamber may be disposed along the flow path downstream of the extruder. The incorporation chamber may include a channel that partially defines the flow path. The incorporation chamber may supply the fibers to the channel. A rotatable nozzle may partially define the flow path downstream of the incorporation chamber. A motor operatively connected to the rotatable nozzle may rotate the rotatable nozzle about a longitudinal axis of the flow path. During operation, the thermoplastic melt receives the fibers within the incorporation chamber and the rotating nozzle imparts a torsional shear to the thermoplastic melt such that the fibers become entangled and helically oriented within the thermoplastic as filament is extruded from the rotatable nozzle.

### CROSS REFERENCE TO RELATED APPLICATIONS

This application claims the benefit of U.S. Provisional Application No. 63/714,518 filed Oct. 31, 2024, the entirety of which is herein incorporated by reference.

### TECHNICAL FIELD

This disclosure relates to advanced composite materials and, in particular, to carbon-fiber reinforced polymers.

### BACKGROUND

In recent years, Carbon Fiber Reinforced Polymers (CFRPs), have become increasingly desirable thanks to their high strength, lightweight, and durable properties. Despite the allure of CFRPs based on their mechanical properties, the production of virgin carbon fiber is highly energy intensive, and the recycling of CFRPs is a costly and destructive process. Current methods for raw carbon fiber recycling include chemical, thermal, and mechanical recycling. Often, the fiber length decreases significantly during the mechanical recycling process, yet this is the cheapest and cleanest method of recycling fibers for reuse in a circular market. Since the strength of a fiber corresponds to the length, shorter fibers cannot bear as much load as continuous fibers. When the recycled shorter fibers are repurposed in an extrusion additive manufacturing process, the parts are weaker due to reduced fiber length. Here, we present an extrusion manufacturing process that can increase the strength of the parts using recycled fibers by winding them together.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an exploded view of an example of an extrusion system for fiber reinforced polymer filament.

FIG. 2 illustrates a side view of an example of an extrusion system for fiber reinforced polymer filament.

FIG. 3A-B illustrates an example of an incorporation chamber.

FIG. 4 illustrates an example of the rotating nozzle and drive mechanism.

FIG. 5 illustrates an example of a nozzle assembly.

### DETAILED DESCRIPTION

Human ambition is the driving force behind all innovation. The desire to build stronger, to build lighter, and to build faster calls for the materials used in innovation to follow suit. This evolution has given rise to the prevalence of fiber-reinforced high-performance composite materials, most notably of which are reinforced with carbon fiber. Carbon Fiber Reinforced Polymers (CFRP), consisting of long carbon fibers bound in a polymer matrix, provide a high strength-to-weight ratio, making them useful in many industries: from aerospace to automotive to renewable energy.

However, as the demand for these materials increases, the shortcomings in their lifecycle have likewise become increasingly apparent. The production process of virgin continuous carbon fibers is costly, both financially and environmentally, posing a threat to the already tenuous health of our planet's atmosphere. Furthermore, the current lifecycle for carbon fiber composites is unsustainable, as today “62,000 tonnes of un-utilized end-of-life (EoL) carbon fiber waste is accumulated each year”. While there are methods to recycle carbon fiber composites while maintaining their characteristic strong continuous fibers, namely thermal and chemical recycling, these come at a high energy cost, mitigating the positive effects of recycling.

A third recycling method involves mechanical recycling, which breaks down the long fibers from carbon fiber composite parts into short fibers. By breaking down the fibers, the high tensile strength inherent in the continuous fibers is lost. However, this process comes with a substantially reduced energy cost compared to thermal and chemical recycling and is the best suited to industrial scale recycling.

Currently, mechanically recycled short fibers have been used as reinforcement for filament used in FFF (Fused Filament Fabrication) additive manufacturing. The already shortened fibers are often further shortened during extrusion and incorporated into a thermoplastic binder to allow the creation of stiffer parts. Despite the increase in flexural stiffness, the increase in the tensile strength of these filaments over their nonreinforced counterparts is negligible, especially when compared to current market solutions for continuous carbon fiber 3D printing, creating a wide gap in market options for high-strength FFF filament.

The system and methods described herein according to some embodiments, utilize mechanically recycled fibers and raw filament to create high-strength fiber reinforced FFF filament through fiber twisting. The system and methods described herein, in some embodiments, utilize torsional viscous forces within thermoplastic melt to create a filament with greater tensile strength than current recycled fiber reinforced filaments and a product which has a cost benefit that rivals continuous fiber filaments. This filament would hold potential to revolutionize the fiber recycling and additive manufacturing industries, simultaneously providing a more cost-effective way to quickly manufacture high strength parts and utilize recycled fibers in an energy-efficient and sustainable manner.

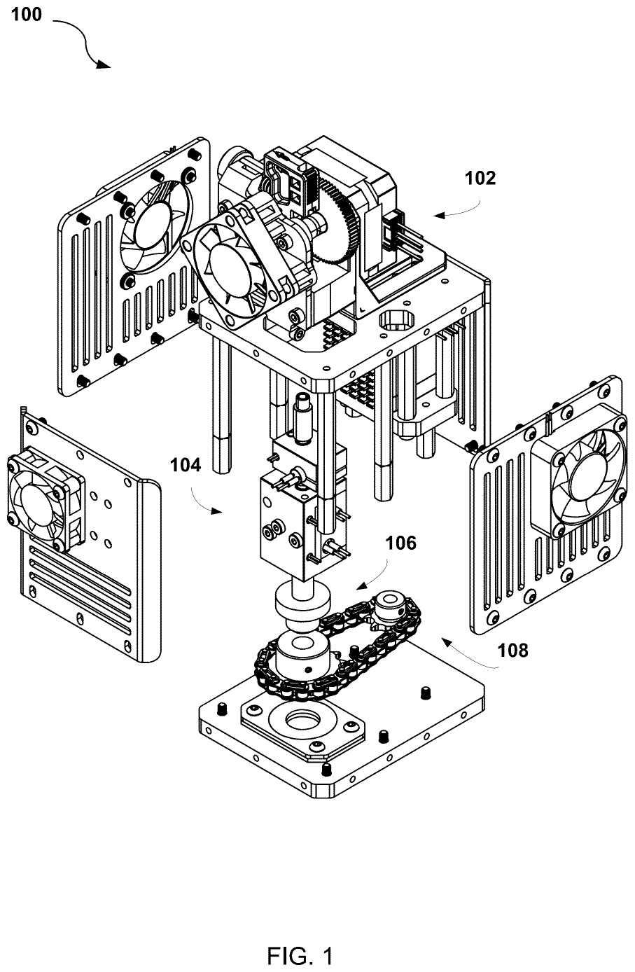

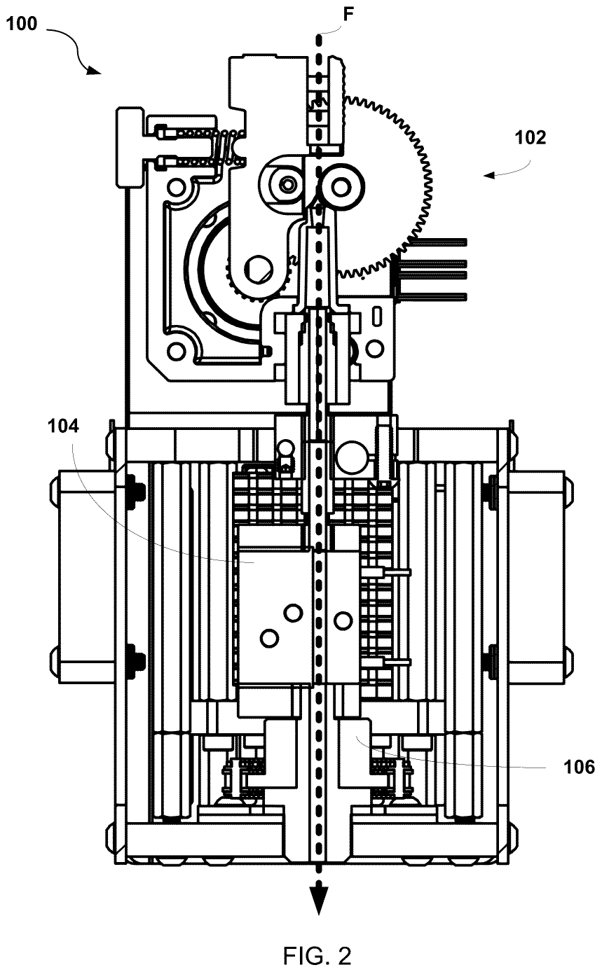

FIG. 1 illustrates an exploded view of an example of an extrusion system 100 for fiber reinforced polymer filament. FIG. 2 illustrates a side view of an example of the extrusion system 100. The system 100 may include an extruder 102, an incorporation chamber 104, a nozzle assembly 106, and a mechanical drive 108 which together define a flow path F (FIG. 2 shows a clear view of the flow path F using a dashed line for reference).

The system 100 may insert raw fibers into the thermoplastic melt as it travels along the flow path F. The system 100 may twist the thermoplastic melt with the fibers to impart torsional shear to the melt such that the fibers become entangled and helically oriented within the thermoplastic.

The extruder may at least partially define the flow path F. The extruder 102 may heat the thermoplastic to form a thermoplastic melt (also referred to as a melt) that flows along the flow path F. The extruder 102 may receive thermoplastic in various forms, including in spool form. For example, the extruder 102 may receive a spool of thermoplastic, which is softened via heat to become the thermoplastic melt. The extruder 102 may heat the thermoplastic to form a melt and them force the thermoplastic melt though an extrusion nozzle oriented along the flow path F. The extruder 102 may be operatively controller to control various parameters, including the heat applied to the thermoplastic and the rate at which the extrusion occurs. For example, the extruder 102 may include a heating element which may apply heat to the nozzle or other components in contact with the thermoplastic. A motor, such as a stepper motor, may drive a toothed gear which feeds the thermoplastic through the extruder 102.

The incorporation chamber 104 may be positioned downstream of the extruder 102 and receive the melt from the extruder 102. The incorporation chamber 104 may include a channel that partially defines the flow path F. The incorporation chamber 104 may store fibers and supply the fibers to the channel and thereby the thermoplastic melt flowing through the channel/flow path F.

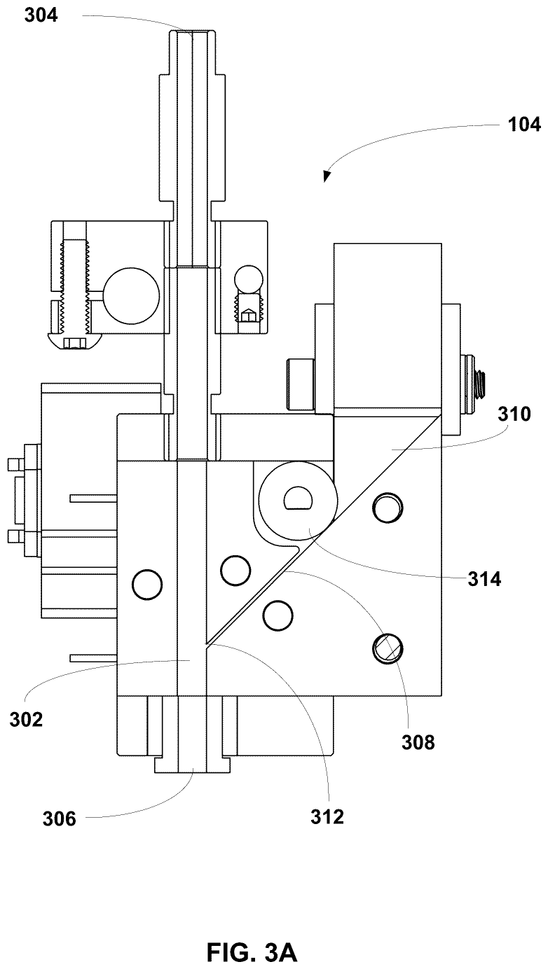

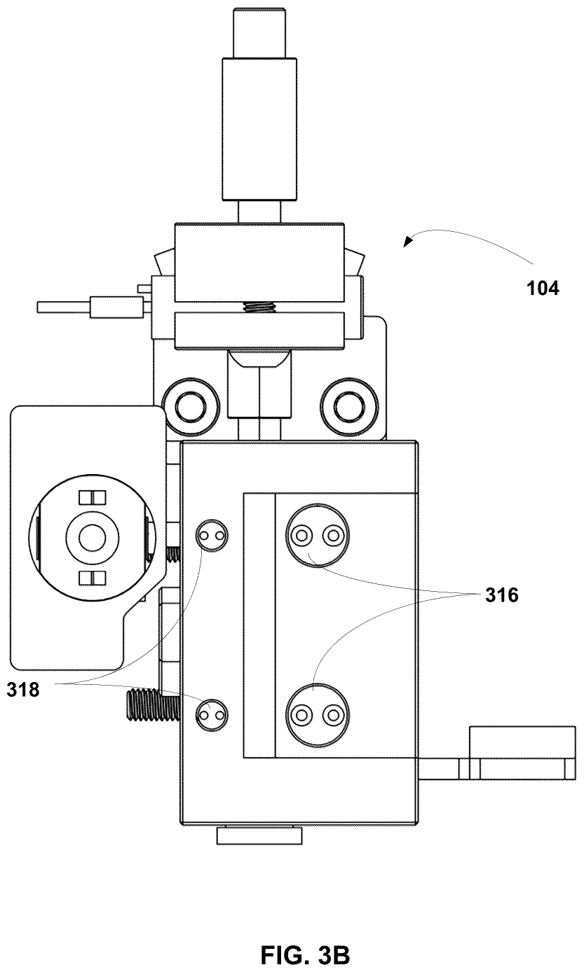

An example of the incorporation chamber 104 is shown FIG. 3 and described in the related text.

The system 100 may include a rotatable nozzle assembly 106. The rotatable nozzle assembly 106 may partially define the flow path F. The nozzle assembly 106 may rotate about the longitudinal axis of the flow path F. The rotatable nozzle assembly 106 may apply a torsional shear to the thermoplastic melt such that the fibers become entangled and helically oriented within the thermoplastic as the thermoplastic is extruded out of the rotatable nozzle assembly 106.

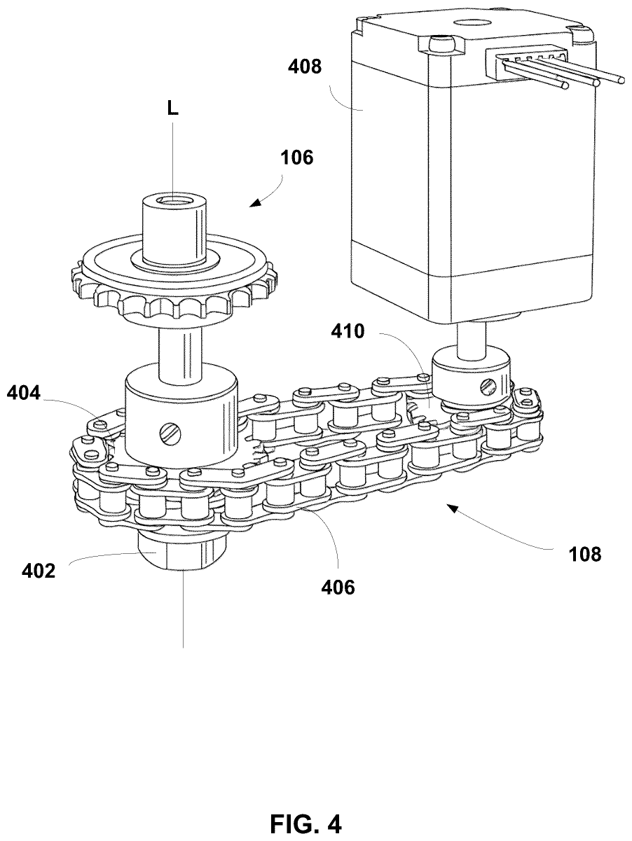

The drive mechanism 108 may be operatively connected to the rotatable nozzle assembly 106. The drive mechanism may cause the nozzle assembly 106 to rotate about the flow path F. An example of the rotating nozzle assembly 106 and drive mechanism 108 is shown FIG. 4 and described in the related text.

During operation, the system 100 may receive premade filament spool of choice and short fibers (typically on the order of ½″ to 1″ in length, though not limited to these lengths) as input. The fibers may be carbon fibers, fiber glass, aramid, and/or other natural or synthetic fibers. The extruder 102 melts the filament through a 3D printer extruder block and pushes it through a wide channel (e.g. 3 mm wide). While the filament is in a melted state, it will encounter preloaded short fibers in the incorporation chamber 104, which draws the fibers into the melt. Further extrusion through the channel aligns the fibers, and the reinforced filament exits through an opening of the nozzle assembly 106. The drive mechanism, such as a chain and sprocket drivetrain, may apply a torsional load to the filament as it is output to entangle the fibers internally in the thermoplastic as it is extruded.

The system may be controlled via a 3D printer control board which allows for closed loop feedback for regulating heating element temperatures and a tunable method for extruding at the desired rate and actuating the spinning nozzle assembly 106. Finally, the extruding components are protected with side panels and thermally isolated with insulation, air gaps, and cooling fans.

Compared to traditional fiber reinforced filament extruders, which take thermoplastic pellets and milled short fibers (typically on the order of 100 micron) as input and utilize a screw drive to melt, homogenize, and push the filament through a nozzle assembly 106 opening, this system works different. Through some research, it was found that the screw drive agitation only further broke down the carbon fiber pieces smaller, making it more difficult to entangle strands and build up to the strength of continuous fibers. As a result, the system and methods described herein retains the length of the short fibers while allowing for a method to add more continuity to already short fibers for increased strength.

FIG. 3A illustrates a cutaway view of an example of the incorporation chamber 104. FIG. 3B illustrates a side view of the example of the incorporation chamber. After the filament is preheated to a melting temperature and provided to the incorporation chamber 104, chopped fiber may be added to the melt.

The incorporation chamber 104 may include channel 302. The channel 302 may define at least a portion of the flow path F downstream of the extruder 102 shown in FIGS. 1 and 2. Accordingly, the channel 302 of the incorporation channel may also be interchangeably referred to as the flow path F. The channel 302 may have an inlet 304 and an outlet 304. The inlet may receive the thermoplastic melt. The melt may receive fibers along the channel 302, and the integrated thermoplastic melt and fiber mix may exit the outlet 306 of the channel 302.

The incorporation chamber 104 may have a passage 308 that stores and supplies the fibers to the channel 302. The passage may have a fiber inlet 310, which receives the fibers, and a fiber outlet 312 which is connected to the channel 302. For example, the fiber outlet 310 may positioned along the channel 302 and may release the fiber into the filament tin the channel.

In some examples, the passage 308 and/or the fiber inlet 310 may be tapered to facilitate funneling the fiber to the fiber outlet 312 and into the channel 302. The incorporation chamber 104 may include a hopper for storing the fibers. The copper may be connected to the inlet 310. Alternatively or in addition, the inlet itself may serve as a hopper for the fibers.

The passage 308 may be oriented down, with respect to gravity and the flow path F. Accordingly, the fiber inlet 310 may be higher than the fiber outlet 308 with respect to the flow path F and gravity. In so doing, the fibers may be fed into the channel 302 through gravity assist. In some examples, the incorporation chamber 104 may be completely passive without the use of roller assists. For example, the passage may be sufficiently angled with respect to the channel 302 that the adhesive properties of the melt flowing through the channel 302 may draw the fibers via gravity assist. Alternatively, the incorporation chamber 104 may include a mechanical feed to assist the fibers through passage 308. The mechanical feed may include, for example, a roller or plunger which is activated by a motor. Activating the mechanical feed may cause the fibers to be pushed and fed through the incorporation chamber and into the thermoplastic melt.

For example, as illustrated in example shown in FIGS. 3A-B, the incorporation chamber 104 may include a roller 314 to assist with the movement of fiber along the passage 308. The roller may be powered by, for example, a motor which allows variable speed and/or incremental rotation (i.e. a stepper motor). Other ways of mechanical assistance are possible. For example, a plunger may be used in the hopper, inlet, or passage to force the fibers through the passage. The motor may be controlled to vary the amount of fiber supplied to the channel 302.

In some examples, the incorporation chamber 104 may include a heating element 316, or multiple heating elements, along the channel 302. The heating element(s) 316 may be selectively activated to regulate the thermoplastic's viscosity as it passes through the chamber 104. In addition, the incorporation chamber may include one or more thermistors 318 which are used to measure the temperature of the channel 302 and/or the melt flowing in the channel 302. The thermal output of the element may be modulated to achieve a desired chamber temperature to promote optimal incorporation of fibers within the thermoplastic. For example, if the temperature acquired by the thermistor(s) lowers below a pre-defined threshold value, the system may engage the thermistor(s) along the channel 302.

FIG. 4 illustrates an example of the rotating nozzle assembly 106 and drive mechanism 108. The nozzle assembly 106 may connect to the device downstream of the incorporation chamber 104. The nozzle assembly 106 may be rotatably coupled to the incorporation chamber 104, or some other component downstream of the incorporation chamber 104.

The nozzle assembly may include a nozzle 402, which rotates about a longitudinal axis L. The nozzle assembly may further include a sprocket 404 which couples to a chain 406 (or a roller in the case of belt) of the drive mechanism 108. In some examples, the sprocket 406 may be detachably coupled to the nozzle assembly 106 and may be secured using a fastener for ease with maintenance and serviceability. If increased modularity for the filament diameter is desired (e.g. to create 1.7 mm filament), the end of the nozzle assembly 106 could be threaded to accommodate a detachable nozzle end for minimal invasiveness.

The drive mechanism 108 may include a motor 408, such as a stepper motor, which may variably control the rotation of the nozzle assembly 106. A shaft may extend from the motor 408 which is connected to a sprocket 410 (or roller in the case of a belt). The sprocket 410 may connect to the chain/belt 406 which is also connected to the nozzle assembly 106. In some examples, a NEMA 11 stepper motor, or the like, may be utilized which easily interfaces with control software to set a rotational rate. In an example used during various experimentation, a pinion on the motor drives the sprocket fixed to the nozzle assembly 106 with a 16:9 ratio—via a chain for increased thermal isolation and torque.

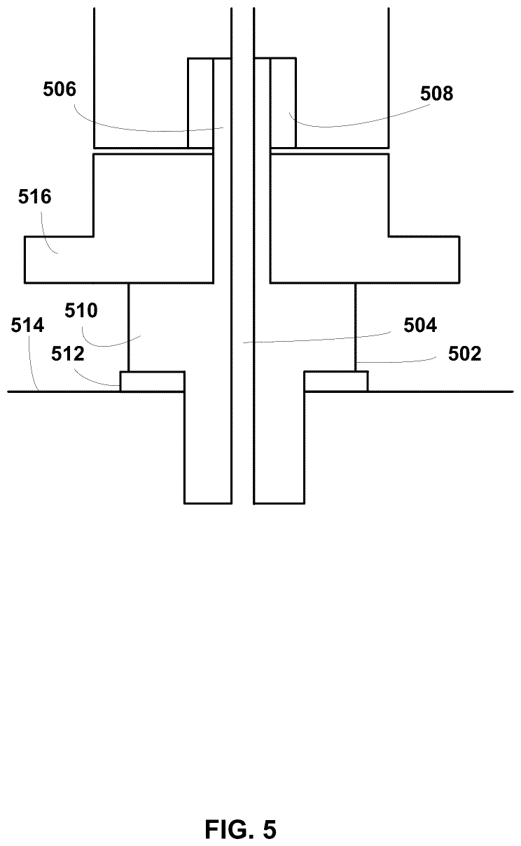

FIG. 5 illustrates an example of a nozzle assembly 106. The nozzle assembly may include a nozzle 502 having an internal passageway 504, which serves as the flow path F. A top end of the nozzle may have a post 506 designed with a slip fit tolerance to slide into a bushing 508 in the incorporation chamber 104, or other component along the flow path F. The nozzle 502 may include a shelf 510 below the post 506. The shelf 510 and post 506 may, together, define the internal passage way. The shelf 510 may have a diameter larger then the post. A bottom side of the shelf 510 may rest on a thrust washer 512 positioned between the shelf 510 and a bottom plate 514.

A sprocket 516 or wheel may be attached to the nozzle 502 between the shelf 514 and the IC (or other top mounting structure). In some examples the sprocket 516 may be detachably coupled to the nozzle 502 or formed integrally with the nozzle 502.

The nozzle 502 may be constrained axially by a compressive load applied at the bottom plate, which also prevents leakage at the bushing interface. This set up allows for the nozzle 502 to rotate with relatively low friction as it is fixtured by the axial moment from the chain on the sprocket. No rotary unions or complicated drive train.

A variety of tuning parameters on the hardware may be controlled to affect the consistency and properties of the output filament. The thermal output of the heaters contained within both the extruder 102 and the incorporation chamber 104 may be adjusted to control the temperature—and therefore viscosity—of the thermoplastic as it passes through the system. The rotational speed of the fans affixed to the extruder 102 and enclosure plates may be adjusted to further control the temperature of the components exposed on the surface of the system, by increasing or decreasing the flow of ambient air to the system, thus inducing forced convection at controlled rates. This may be used to prevent the overheating of temperature-sensitive components, as well as serving as another means of controlling the temperature of the thermoplastic as it passes through the system by way of controlling the heat transfer at the components' external surfaces. Any additional fans included with the intention of affecting the cooling rate of the filament output from the nozzle may have a controlled rotational speed to increase or decrease the convection heat transfer from the filament to the environment. The rotational speed of the feed motor(s) within the extruder 102 may be used to control the axial feed rate of the filament, while the speed of the motor in the nozzle drive mechanism can affect the torsional shear applied to the thermoplastic, thus affecting the orientation of the fibers within the resultant filament.

After the filament exits the nozzle, it may be cooled down, binding the fibers together. In some examples, the nozzle will act as a heat exchanger to cool the plastic just enough to the glass transition temperature. However, controlling this is difficult and running too cool increases the chance of clogging the nozzle. Therefore, it was expected that the filament will still be above it's glass transition temperature when exiting the nozzle. Since this part of the system is open to the environment, free convection with the ambient air will act to cool the filament into a solid state and if needed, additional fans may be added to increase the cooling.

The temperature of the plastic entering the nozzle can be controlled by the heater cartridge and thus the amount of cooling was estimated with a thermal FEA model of the incorporation chamber 104 and twisting nozzle. An estimated cooling of about 70° C. is expected within the nozzle but the temperature is still around 180° C., the suggested melt temperature of PLA. Therefore, the nozzle is expected to remain hot enough for successful filament extrusion.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. An extrusion device for fiber reinforced polymer filament comprising:
an extruder configured to output a thermoplastic melt into a flow path;
an incorporation chamber disposed along the flow path downstream of the extruder, the incorporation chamber including a channel that partially defines the flow path, the incorporation chamber configured to supply the fibers to the channel;
a rotatable nozzle partially defining the flow path downstream of the incorporation chamber; and
a motor operatively connected to the rotatable nozzle and configured to rotate the rotatable nozzle about a longitudinal axis of the flow path;
wherein, during operation, the thermoplastic melt receives the fibers within the incorporation chamber and the rotating nozzle imparts a torsional shear to the thermoplastic melt such that the fibers become entangled and helically oriented within the thermoplastic as the filament is extruded from the rotatable nozzle.

2. The extrusion device of claim 1, wherein the motor is configured to rotate the nozzle about a longitudinal axis of the flow path at a selectable rotational speed.

3. The extrusion device of claim 2, further comprising a chain or belt connecting a motor output shaft to the rotatable nozzle.

4. The extrusion device of claim 3, wherein the nozzle comprises a sprocket configured to receive the chain.

5. The extrusion device of claim 1, wherein the incorporation chamber comprises a fiber outlet configured to introduce fibers into the channel.

6. The extrusion device of claim 5, wherein the incorporation chamber comprises a passageway disposed between the fiber outlet and a fiber inlet configured to receive the fibers.

7. The extrusion device of claim 6, wherein the fiber inlet is positioned above the fiber outlet with respect to gravity.

8. The extrusion device of claim 6, wherein the incorporation chamber comprises a mechanical feed configured to urge the fibers along the passageway and into the thermoplastic melt.

9. The extrusion device of claim 8, wherein mechanical feed comprises a roller which rotates along the passageway.

10. The extrusion device of claim 6, wherein the incorporation chamber comprises a fiber reservoir configured hold to the fibers and feed them gravitationally or mechanically into the passageway.

11. The extrusion device of claim 1, further comprising a first heating element configured to control the temperature of thermoplastic melt leaving the extruder and a second heating element configured to heat the thermoplastic melt flowing in the incorporation chamber, wherein the first heating element and second heating element are selectively controlled to regulate the viscosity of the thermoplastic melt at various points along the flow path.

12. The extrusion device of claim 1, wherein the fibers have an average length between 0.1 mm and 5 mm.

13. The extrusion device of claim 1, wherein the nozzle is connected directly to the incorporation chamber.

14. A method for making a reinforced polymer filament, comprising:
extruding a thermoplastic melt into an incorporation chamber;
injecting fibers stored in the incorporation chamber into the thermoplastic melt;
providing the mixture of thermoplastic melt and fibers to a rotatable nozzle downstream of the incorporation chamber;
rotating the rotatable nozzle; and
extruding the thermoplastic melt from the rotatable nozzle while it is rotating such that the fibers become entangled and helically oriented within the thermoplastic melt to provide the reinforced polymer filament.

15. The method of claim 14, wherein rotating the rotatable nozzle further comprises:
activating a motor operationally connected to the rotatable nozzle via belt or chain.

16. The method of claim 14, injecting fibers stored in the incorporation chamber into the thermoplastic melt further comprises: activating a mechanical feed configured to urge the fibers along a passageway of the incorporation and into the thermoplastic melt.

17. The method of claim 14, further comprising:
regulating viscosity of the thermoplastic melt along a flow path in the incorporation chamber.

18. The method of claim 17, further comprising:
selectively activating at least one heating element in the flow path.

19. The method of claim 14, providing fibers to the incorporation chamber.

20. The method of claim 19, wherein fibers have an average length between 0.1 mm and 5 mm.
